(19) United States
(12) Patent Application Publication
(10) Pub. No.: US 2025/0362937 A1
(43) Pub. Date: Nov. 27, 2025

(54) COMPUTING ARCHITECTURE FOR USER CHARACTERISTIC BASED APPLICATION CONTENT ADJUSTMENT

(71) Applicant: ADP, Inc., Roseland, NJ (US)

(72) Inventor: Connie Hickey, Alpharetta, GA (US)

(73) Assignee: ADP, Inc., Roseland, NJ (US)

(21) Appl. No.: 18/671,661

(22) Filed: May 22, 2024

(51) Int. Cl. G06F 9/451; G06Q 40/12

(52) U.S. Cl. CPC G06F 9/451; G06Q 40/125

(57) ABSTRACT

Technical solutions are directed to a computing architecture for determining user characteristics from interactions with user interface and customizing application-generated content according to the user characteristics. A system can detect interactions with elements of content in a user interface and identify, based on interactions input into a model, a characteristic associated with the account. The system can receive a first content for a human capital management service to be displayed using a graphical user interface, the first content generated by an application. The system can generate, based at least on the first content, an arrangement of elements according to the characteristic and display, on the graphical user interface, the arrangement of elements.

### FIELD OF THE TECHNOLOGY

This disclosure relates to computing technology, and more particularly to using one or more types of machine learning (e.g., generative artificial intelligence, large language models, neural networks, support vector machines, etc.) to adjust application content.

### BACKGROUND

Applications executed by a computer can provide services. However, the format or mode in which the applications provide output may not be adequate or compatible with certain types of interfaces or recipient devices, thereby resulting in erroneous or inefficient downstream processing of the output or service provided by the application.

### SUMMARY

Aspects of technical solutions described herein are directed to a computational framework for automated customization of application-generated content according to client account characteristics detected based on content interactions within a user interface. When serving application content to varying client devices, some of the devices can find the application content to be inadequate or incompatible with particular client account settings or preferences. This can result in data mishandling, miscommunications, or erroneous client device interactions, resulting in computational inefficiencies and increased system energy consumption. For example, inadequate or incompatible application content received by a client device can lead to inefficient device interactions or erroneous data inputs, triggering additional computational processing and use of resources and reducing system efficiency. In such instances, it can be challenging to timely detect or identify the incompatibility between the client devices and the application content to prevent these inefficiencies. The technical solutions of this disclosure overcome these challenges by providing an ML-based computing architecture that monitors client device interactions with the application content to detect client account characteristics based on which to automatically arrange the application content elements according to the client device characteristics. In doing so, the technical solutions improve the adequacy and compatibility of the provided application content, reducing the computational inefficiencies and improving the energy efficiency of the system.

An aspect of the technical solutions described herein is directed to a system. The system can include one or more processors coupled with memory. The one or more processors can be configured to detect one or more interactions with elements of content generated by one or more applications. The one or more interactions can be associated with an account. The one or more processors can be configured to identify, based at least on the one or more interactions input into one or more models trained with machine learning on a plurality of interactions with a plurality of elements of content indicative of a plurality of characteristics, a characteristic associated with the account. The one or more processors can be configured to receive a first content for a payroll service to be displayed using a graphical user interface. The first content can be generated by an application of the one or more applications associated with the account. The one or more processors can be configured to generate, based at least on the first content, an arrangement of elements according to the characteristic. The one or more processors can be configured to display, on the graphical user interface, the arrangement of elements.

The one or more processors can be configured to detect elements of the first content generated by the application responsive to a request associated with the account. The one or more processors can be configured to generate a second content comprising the arrangement of elements of the first content based at least on a setting for the arrangement of elements associated with the characteristic. The one or more processors can be configured to display, on the graphical user interface, the second content responsive to the request.

The one or more processors can be configured to generate, responsive to the characteristic, a setting for the arrangement of elements to accommodate the characteristic. The one or more processors can be configured to store the setting into a profile of the account, the profile including one or more settings for one or more characteristics. The one or more processors can be configured to detect, based at least on a portion of the first content input into the one or more models, that the portion of the first content corresponds to the characteristic. The one or more processors can be configured to generate, responsive to the detection, the arrangement of elements using the one or more models and the portion of the first content.

The one or more processors can be configured to monitor one or more actions on elements of content generated by one or more applications on the graphical user interface. The one or more processors can be configured to detect the one or more interactions responsive to at least an action of the one or more actions input into the one or more models. The one or more processors can be configured to identify a decay function for the characteristic corresponding to anxiety. The one or more processors can be configured to determine that the first content corresponds to a value of the decay function that satisfies a threshold for the characteristic corresponding to anxiety. The one or more processors can be configured to generate, responsive to the determination, the arrangement of elements that corresponds to a second value of the decay function that does not satisfy the threshold for the characteristic.

The one or more processors can be configured to determine that the first content corresponds to a first word count that satisfies a threshold for the characteristic corresponding to the word count. The one or more processors can be configured to generate, responsive to the determination, the arrangement of elements corresponding to a second word count that does not satisfy the threshold for the characteristic.

The one or more processors can be configured to identify that the first content is written in a first language. The one or more processors can be configured to identify that the characteristic corresponds to a second language. The one or more processors can be configured to generate, based at least one the first content, the arrangement of elements of a second content corresponding to the first content and written in a second language. The one or more processors can be configured to generate at least one of the arrangement of elements or the second content using the one or more models trained with machine learning in the first language and the second language.

The one or more processors can be configured to determine that the first content satisfies a threshold for the characteristic corresponding to visual impairment. The one or more processors can be configured to generate, responsive to the determination, the arrangement of elements that does not satisfy the threshold. The one or more processors can be configured to determine that the first content that satisfies a threshold for the characteristic corresponding to at least one of a visual impairment or a hearing impairment. The one or more processors can be configured to generate, responsive to the determination, the arrangement of elements to be sounded over a speaker according to a volume.

The one or more processors can be configured to determine that the first content satisfies a threshold for the characteristic corresponding to a neurocognitive challenge. The one or more processors can be configured to generate, responsive to the determination, the arrangement of elements that does not satisfy the threshold. The neurocognitive challenge includes at least one of: attention deficit hyperactivity disorder (ADHD), dyslexia, autism spectrum disorder (ASD), intellectual disability (ID), specific language impairment (SLI), nonverbal learning disorder (NVLD) and visual processing disorder (VPD).

The one or more processors can be configured to determine that the first content satisfies a threshold for the characteristic corresponding to a level of literacy. The one or more processors can be configured to generate, responsive to the determination, the arrangement of elements that does not satisfy the threshold. The one or more processors can be configured to determine that the first content satisfies a threshold for the characteristic corresponding to a level of proficiency in a field. The one or more processors can be configured to generate, responsive to the determination, the arrangement of elements that does not satisfy the threshold.

An aspect of the technical solutions described herein is directed to a method. The method can include detecting, by one or more processors coupled with memory, one or more interactions with elements of content generated by one or more applications. The one or more interactions can be associated with an account. The method can include identifying, by the one or more processors, based at least on the one or more interactions input into one or more models trained with machine learning on a plurality of interactions with a plurality of elements of content indicative of a plurality of characteristics, a characteristic associated with the account. The method can include receiving, by the one or more processors, a first content for a human capital management service (e.g., a payroll service), to be displayed using a graphical user interface, the first content generated by an application of the one or more applications associated with the account. The method can include generating, by the one or more processors, based at least on the first content, an arrangement of elements according to the characteristic. The method can include displaying, by the one or more processors, on the graphical user interface, the arrangement of elements.

The method can include detecting, by the one or more processors, elements of the first content generated by the application responsive to a request associated with the account. The method can include generating, by the one or more processors, a second content comprising the arrangement of elements of the first content based at least on a setting for the arrangement of elements associated with the characteristic. The method can include displaying, by the one or more processors on the graphical user interface, the second content responsive to the request.

The method can include generating, by the one or more processors, responsive to the characteristic, a setting for the arrangement of elements to accommodate the characteristic. The method can include storing, by the one or more processors, the setting into a profile of the account, the profile including one or more settings for one or more characteristics. The method can include detecting, by the one or more processors, based at least on a portion of the first content input into the one or more models, that the portion of the first content corresponds to the characteristic. The method can include generating, by the one or more processors responsive to the detection, the arrangement of elements using the one or more models, the portion of the first content and the setting.

The method can include determining, by the one or more processors, that the first content satisfies a threshold for the characteristic, the threshold corresponding to at least one of: a value of a decay function corresponding to anxiety, a word count, a language, visual impairment, a hearing impairment, a neurocognitive challenge, a level of literacy or a level of proficiency in a field. The method can include generating, responsive to the determination, the arrangement of elements that does not satisfy the threshold for the characteristic.

An aspect of the technical solutions described herein is directed to a non-transitory computer-readable media having processor readable instructions. The instructions can be such that, when executed, cause at least one processor to detect one or more interactions with elements of content generated by one or more applications. The one or more interactions can be associated with an account. The instructions can be such that, when executed, cause the at least one processor to identify, based at least on the one or more interactions input into one or more models trained with machine learning on a plurality of interactions with a plurality of elements of content indicative of a plurality of characteristics, a characteristic associated with the account. The instructions can be such that, when executed, cause the at least one processor to receive a first content for a payroll service to be displayed using a graphical user interface, the first content generated by an application of the one or more applications associated with the account. The instructions can be such that, when executed, cause the at least one processor to generate, based at least on the first content, an arrangement of elements according to the characteristic. The instructions can be such that, when executed, cause the at least one processor to display, on the graphical user interface, the arrangement of elements.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system that uses machine learning to adjust content generated by an application.

FIG. 2 illustrates a block diagram of an example computing system for implementing the embodiments of the present solution.

FIG. 3 illustrates an example output of a user interface for providing access to a client account to set up user configurations, profile and characteristics.

FIG. 4 is an example of an output of a user interface for updating a user profile and providing configurations or information about characteristics.

FIG. 5 is a flow diagram illustrating an example method for identifying user characteristics from user interactions and customizing application-generated content according to identified user characteristics.

### DETAILED DESCRIPTION

Following below are more detailed descriptions of various concepts related to, and implementations of, methods, apparatuses, and systems for AI or ML based application content adjustment to accommodate user characteristics. The various concepts introduced above and discussed in greater detail below may be implemented in any of numerous ways.

Aspects of technical solutions described herein are directed to a computational framework for automated customization of application-generated content according to client account characteristics detected from content interactions within a user interface. In the process of serving application content to various client devices, the technical challenge arises when the provided content is inadequate or incompatible with the characteristics of some of the client devices or accounts. This can lead to data mishandling and miscommunications, which can lead to inefficient device interactions, resulting in computational inefficiencies and increased energy consumption. For instance, a client device encountering a misfit application content can lead to erroneous inputs and inefficient interactions, triggering additional computational processing and resource utilization. Detecting and preempting such discrepancies in real-time is a technical challenge.

The technical solutions of the present disclosure overcome these challenges by providing ML-based computing architecture that monitors client device application interactions in a user interface to identify unique client device characteristics. Based on the user interface interactions, the technical solutions can utilize machine learning (ML), including, for example, generative artificial intelligence (AI) models, to dynamically adjust the arrangement of application content elements or generate adjusted application content to align with the specifications and preferences of the client device, thus improving the adequacy and compatibility of the application content with respect to individual client devices. In doing so, the technical solutions mitigate computational inefficiencies and improve the energy efficiency of the system.

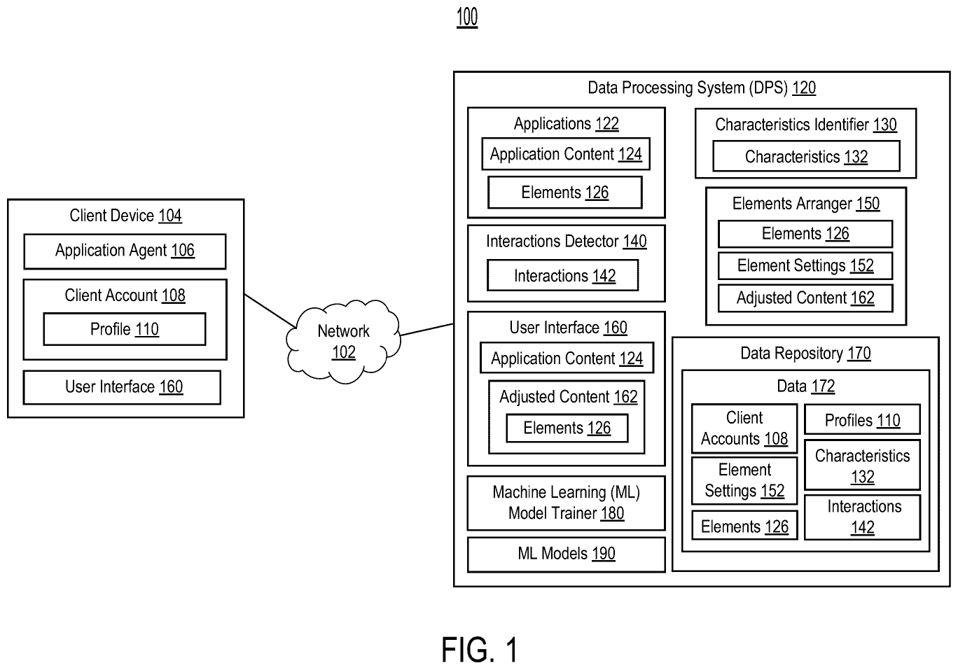

FIG. 1 depicts an example system 100 of an ML-based computing architecture for identifying user characteristics from user interface interactions and customizing application-generated content according to identified characteristics. System 100 can include a client device 104 communicating with a data processing system (DPS) 120 over a network 102. Client device 104 can include one or more client accounts 108 associated with one or more user profiles 110, one or more user interfaces 160 and one or more application agents 106 for utilizing one or more applications 122 that can be executed on a DPS 120. DPS 120 can include one or more applications 122, interaction identifiers 130, interactions detectors 140, elements arrangers 150, user interfaces 160, data repositories 170, machine learning (ML) model trainers 180 and ML models 190. An application 122 can include or generate application content 124 that can include elements 126 to be displayed on user interface 160. A characteristics identifier 130 can detect, recognize, or identify characteristics 132 of user profiles 110 associated with client accounts 108. An interactions detector 140 can detect, identify, or recognize different user interactions 142 with elements 126 of the application content 124 to determine characteristics 132 associated with the client account 108 of a user. An elements arranger 150 can configure, adjust, modify, reconfigure, edit, or arrange elements 126 according to element settings 152 to provide, produce or generate an adjusted content 162 according to the arranged elements 126. A user interface 160 can provide, display, or present the application content 124 or the adjusted content 162 according to the elements 126 for the user. A data repository 170 can include or store any data 172, including accounts 108, element settings 152, profiles 110, characteristics 132, elements 126 and interactions 142 that can be accessed or used by any of the components of the DPS 120, such as the ML model trainer 180 for training ML models 190, or by ML models 190 facilitating or implementing the functionalities of the characteristics identifiers 130, interactions detectors 140 and elements arrangers 150.

In an example, a user associated with a client account 108 on a client device 104 can utilize an application agent 106 to request or access application content 124 from one or more applications 122 on a DPS 120. The application content 124 can be generated by the applications 122 and provided via user interface 160. As the user can interact with the elements 126 of the application content 124 in the user interface 160, the interactions detector 140 can detect certain interactions 142 that are indicative of the characteristics 132 of the user (e.g., different levels of difficulties, disabilities or traits making it desirable to modify the application content). For instance, the interactions detector 140 can use ML models 190 (e.g., generative AI models) trained by the ML model trainer 180 to detect and identify the specific interactions 142 indicative of the characteristics 132. The characteristics identifier 130 can detect, recognize, or identify the characteristics 132 of the user associated with a client account 108, using for example the ML models 190 trained to identify the characteristics 132 based on the interactions 142. The elements arranger 150 can generate element settings 152 to create to configure, reconfigure, create, edit, arrange, or rearrange elements 126 to provide the adjusted content 162 with the elements 126 arranged to accommodate the characteristics 132. For instance, the elements arranger 150 can utilize ML models 180 trained to arrange the elements 126 to accommodate the characteristics 132. The user interface 160 can provide the adjusted content 162 that includes the elements 126 arranged according to (e.g., accommodating) the characteristic 132 (e.g., of the user) associated with the client account 108, thereby making the provided application content more suitable and useful to the user.

Client device 104 can include any combination of hardware and software for a user associated with a client account 108 to access an application 122. Client device 104 can include a computing device configured for communication, such as a computer, smartphone, or a wearable device. Client device 104 can execute one or more application agents 106 for accessing or using applications 122 to generate application content 124. Application agents 106 can include any combination of hardware and software, including computer script or code, for using or accessing one or more applications 122 executed on a remote DPS 120 or a client device 104. Application agent 106 can include an interface or functionality for requesting the content from the applications 122 and receiving application content 124 (e.g., via a user interface 160).

Client device 104 and the DPS 120 can communicate via a network 102. Network 102 can include any type and form of a network or medium for transmitting communications or data. Network 102 can include any combination of a wires and wireless connections or communication nodes or devices. Network 102 can include a cellular network, a wireless local area network (WLAN) provided by one or more access points (e.g., Wireless Fidelity or Wi-Fi routers), one or more LANs or the Internet. Network 102 can include Bluetooth communications, wireless links or any peer to peer communications allowing exchange of data (e.g., application content 124 or adjusted content 162).

Application 122 can include any combination of hardware and software, such as a software program executed on computing device (e.g., client device 104 or a DPS 120). Application 122 can include the functionality, computer code or instructions for generating application content 124 (e.g., output files, text, or multimedia). Application 122 can include any type and form of an application that a client device 104 can access, execute, or use on the client device 104 or remotely on a DPS 120. Application can include an application for a payroll service, such as an application for calculating or processing employee wages (e.g., salaries or bonuses), tracking attendance of employees, tracking project or work progress, preparing or filing taxes for an enterprise or employees, providing access to employees for their payroll information, such as pay stubs or personal data, an application for managing employee benefits plans, or any business or enterprise related application for any payroll service or product. Application 122 can include or involve a multimedia application, a streaming application, a web application, a mobile device application, a text or document editor application, or any other application provided by a computing device (e.g., DPS 120).

Application content 124 can include any output provided by the application 122, such as a file, textual output, data, multimedia (e.g., audio or video output), graphical features (e.g., icons, images or features), field or topic specific content or specifications, data sheets, technical or legal documents, tax codes or instructions, or any other type or form of content from any application 122. Application content 124 can be generated responsive to a request from a client device 104 for a particular application content 124 (e.g., responsive to the user request via an application agent 106).

Application content 124 can include any number of elements 126 that can include or correspond to any portion of data or output that constitute the application content 124. Elements 126 can include portions of text, images, videos, symbols, characters, buttons, menus, forms, or information that can be a part of the application content 124. Elements 126 can be arranged or organized and presented on a user interface and form building blocks of the presented content, such as the application content 124 or the adjusted content 162. Elements 126 can include content arranged, organized, or created for speakers of a specific language, practitioners of a particular field using particular specialized field-specific terms or acronyms, topics described using a particular level of literacy or describing different levels of complexity of issues presented.

Elements 126 can include portions of words, phrases, sentences, or paragraphs organized in a particular way and to accommodate one or more characteristics 132 associated with a particular profile 110 of a particular client account 108. Elements 126 can be arranged, modified, or adjusted according to element settings 152 in order to accommodate characteristics 132. For example, elements 126 of an application content 124 generated by an application 122 can be arranged by an elements arranger 150 using, based on, or in accordance with element settings 152 in order to conform to or characteristics 132 associated with a client account 108 of a user.

Interactions 142 can include any actions indicative of engagement of a user with features (e.g., elements 126) of an application content 124. Interaction 142 can include any action indicative of a user's behavior, preference, or pattern of engagement indicative of, or related to, a characteristic 132. Interactions 142 can include actions, such as clicking, tapping, scrolling, typing, swiping, voice commands. Interactions 142 can include actions, such as online web searching or researching of a topic, a word, a sentence, a phrase, or an acronym in an application content 124. Interactions 142 can be indicative of a particular level, or lack of a level, of familiarity with a field or a topic, a language, or a type of text. For instance, an interaction 142 can include an online action or a search to translate a text from a first language to a second language, which interaction detector can equate with a characteristic 132 of a user's inability to understand the first language. Interaction 142 can include an action to increase the font or zoom into a particular one or more features of a text or image of application content 124 displayed in a user interface 160, which can indicate visual impairment. Interaction 142 can include turning the volume of a video or audio file beyond a particular level, which can indicate a hearing impairment. Interaction 142 can include searching for the meaning of particular terms or concepts discussed in a text of an application content 124, which can be indicative of unfamiliarity with a field or a topic. Interaction 142 can include actions taken inconsistent to instructions or text description which can be indicative of a neurological issue limiting the user's ability to understand the application content 124.

Characteristics 132 can include any features, attributes or traits associated with users of the client accounts 108 that can impact the user's interaction with application content 124. Characteristics 132 can include various personal traits or attributes, including medical or cognitive disability or condition, a language proficiency, educational background, neurodiversity characteristics (e.g., difference in social preferences, ways of learning or communicating or ways of perceiving environment) cognitive abilities, literacy levels, familiarity with specific topics or fields, and task-related anxieties. Characteristics 132 can include or correspond to visual or hearing impairment, inability to understand text in a particular field or topic, or insufficient level of familiarity or education in a particular field or issue. Characteristics 132 can include neurocognitive challenge, such as attention deficit hyperactivity disorder (ADHD), dyslexia, autism spectrum disorder (ASD), intellectual disability (ID), specific language impairment (SLI), nonverbal learning disorder (NVLD) and visual processing disorder (VPD).

Characteristics 132 can include any biodiversity related attributes or characteristics in order to accommodate people whose brains work differently from those of average or neurotypical persons. For instance, characteristics 132 can include neurodivergent characteristics in which a person can prefer a different way of communicating or learning or differently perceive the environment from other persons. Neurodivergent characteristics 132 can include, for example, autism spectrum disorder (e.g., Asperger's syndrome), ADHD, Tourette syndrome, dyslexia, obsessive-compulsive disorder, down syndrome, dyscalculia (e.g., difficulty with mathematics), dysgraphia (e.g., difficulty with writing), dyspraxia (e.g., difficulty with coordination), intellectual disabilities, mental health disorders (e.g., bipolar disorder), Prader-Willi syndrome, sensory processing disorders, social anxiety or Williams syndrome.

Adjusted content 162 can include any content provided by elements arranger 150, including arranged, rearranged, reconfigured, readjusted, or edited elements 126 corresponding to, or accommodating, characteristics 132. Adjusted content 162 can include elements 126 arranged or rearranged according to element settings 152. Adjusted content 162 can include arranged elements 126 configured to satisfy thresholds for characteristics 132. The threshold can include a threshold that at least one of a characteristics identifier 130 or an elements arranger 150 can use to determine if the content (e.g., 124 or 162) to be displayed for the user via a user interface 160 conforms to or otherwise accommodates the characteristic 132 of the user. The threshold can include any threshold for testing or determining (e.g., by a characteristics identifier 130 or an elements arranger 150) whether the content to be displayed on a user interface 160 is in accordance with any characteristic 132, such as a preferred language, level of literacy, level of education or familiarity with a particular specialized field, anxiety level or any other characteristic or a user trait.

Client account 108 can include any data corresponding to a user associated with characteristics 132. Client account 108 can include a digital data indicative of an identity of the user within the system, history of usage of files or information pertaining to the user or history of interactions 142. Client account 108 can include a user profile 110, user characteristics 132 and element settings 152 for providing or generating elements 126 of the adjusted content 162.

Profile 110 can include any personalized data or configuration for the client account 108. Profile 110 can include preferences and settings for the client account 108, including element settings 152 for converting application content 124 into adjusted content 162 or for rearranging, modifying, adjusting, or editing the elements 126 of the application content 124 into adjusted content 162. Profile 110 can include characteristics 132, such as preferred language, literacy level, medical or cognitive disability, anxiety with new or unfamiliar topics or any other features or characteristics of the user with respect to the content. Profile 110 can include user characteristics 132 that can be entered into the profile or client account 108 via a user interface 160. For instance, profile 110 can include one or more characteristics 132 entered into the profile 110 by a user per a prompt in a user interface 160 requesting the user to identify characteristics 132. For instance, per profile 110 prompt via a user interface 160, the user (e.g., associated with account 108) can enter information or data on the user's literacy level, level of education, level of anxiety for a given field, topic or a type of content, level of sight or hearing limitations, level or presence of neurological or other medical conditions. Characteristics identifier 130 can determine, detect, or recognize the characteristics 132 of the user based on the entered characteristics-related information or data entered by the user into the profile 110.

Data repository 170 can include any combination of hardware and software for storing data 172. Data repository 170 can include devices for storing digital information, such as physical or virtual storage hard disk drives (HDDs), solid-state drives (SSDs), magnetic tapes, or cloud-based storage services. Data repository 170 can include any device or a system for storing, managing, and preserving data 172 in a structured and organized manner for future retrieval and use. Data repository 170 can include data structures for storing information about specific client accounts 108 and user profiles 110. For instance, data repository 170 can include data structures for storing characteristics 132 and element settings 152 for any particular client account 108 or its profile 110.

Data 172 can include any digital information including or corresponding to contents, information, data, instructions, commands, computer code, configurations or settings including or corresponding to client accounts 108, profiles 110, element settings 152, characteristics 132, elements 126 and interactions 142. Data 172 can be organized in individual data structures for individual client accounts 108 or profiles 110 associated with individual users. Data 172 can include interactions 142, characteristics 132 and element settings 152 of each individual profile 110 or client account 108. Data 172 can include data structures associating element settings 152 with the characteristics 132 for each individual client account 108, allowing the elements arranger 150 (e.g., or its ML models 190) to access the given element settings 152 in order to generate adjusted content 162 and its corresponding arrangements of elements 126 (e.g., rearranged or reconfigured elements 126 of the adjusted content 162).

Machine learning (ML) models 190 can include any number of machine learning or artificial intelligence (AI) models for providing application content adjustment according to characteristics 132. ML models 190 can include any type and form of ML or AI models trained or configured to perform, facilitate, or implement any functionalities of interaction detector 140, characteristics identifier 130 and elements arranger 150. ML models 190 can include any type and form of AI or ML models, such as classification models or generative models. For instance, ML models 190 can be configured or designed to categorize input data, such as actions taken by users in user interface 160, into predefined classes or categories, such as interactions 142 that can be associated with characteristics 132. For instance, ML models 190 can be configured or designed to categorize input data, such as interactions 142, into categories, such as characteristics 132. ML models 190 can include models trained to establish or generate element settings 152 based on the characteristics 132. ML models 190 can be trained to generate adjusted content 162 (e.g., arranged elements 126) based on application content 124, characteristics 132 or element settings 152.

ML models 190 can include any type and form of artificial intelligence (AI) models implementing any AI techniques. For instance, ML models 190 can include generative AI models trained or designed to learn patterns and make predictions from data, including models that are trained to generate new content resembling distributions of data on which they are trained. ML models 190 can include generative AI models constructed using variational autoencoders (VAEs), designed to learn latent representations of data and generate new samples based on the representations. ML models 190 can include generative AI models constructed using generative adversarial networks (GANs) that can use a generator and a discriminator to produce a determination or an output. ML models 190 can include generate AI models constructed using transformers, which can be designed to learn features or inferences based on sequence-to-sequence capabilities. ML models 190 can utilize generative AI functionality to train and adapt to user characteristics, preferences, or device specifications. For instance, ML model 190 can utilize VAEs to learn representations of user characteristics 132 to generate adjusted content 162 according to the characteristics 132. For instance, ML model 190 can utilize GANs can generate device-specific content (e.g., according to characteristics 132 associated with the client device 104 associated with a particular client account 108 of the characteristics 132) by learning patterns or inferences from device data distributions, such as distributions of relations between application content 124 and adjusted content 162 of other profiles 110. For instance, ML model 190 can utilize transformers to dynamically adjust content sequences based on device interactions, such as interactions 142. For example, ML model can be based on a transformer architecture that uses an attention mechanism or a self-attention mechanism to process input sequences and generate output sequences.

For instance, ML models 190 can include generative models, such as generative adversarial networks (GANs), natural language processing (NLP) models, such as GPT (Generative Pre-trained Transformer) models, or transformer-based model architectures configured to generate new instances of data based on patterns learned during training. ML models 190 can include large language models, neural network models or support vector machines. ML models 190 can be trained to recognize patterns in application content 124 that are inconsistent with or not accommodating to the characteristics 132. ML models 190 can be trained to recognize patterns in interactions 142 of the user with a user interface 160 to determine or identify characteristics 132 from the interactions 142. ML models 190 can be trained to arrange elements 126 or generate adjusted content 162 (e.g., according to element settings 152) to conform application content 124 to the characteristics 132 by arranging elements 126 (e.g., generating adjusted content 162). ML models 190 can include LLMs that can be trained to detect or identify interactions 142 indicative of characteristics 132, or to convert application content 124 provided by application 122 into adjusted content 162 having elements 126 arranged to accommodate the characteristics 132 associated with the profile 110 of the client account 108. ML models 190 can include the functionality to detect, determine or recognize portions (e.g., elements 126) of the application content 124 generated by an application 122 that satisfies or does not satisfy the thresholds or conditions of a particular characteristic 132. ML models 190 can be trained to detect values for application content 124 for various characteristic determinations, such as to evaluate whether the content satisfies or does not satisfy a threshold for characteristic 132.

ML model trainer 180 can include any combination of hardware and software for training ML models 190. ML model trainer 180 can include any computer code, commands, data (e.g., corpora or textual data) for training or retraining machine learning models 190 for any DPS functionality (e.g., interactions detector 140, characteristics identifier 130 or elements arranger 150). ML model trainer 180 can include the functionality for training any type and form of ML models, including generative AI models. For instance, ML model trainer 180 can use various multimedia (e.g., image or video), textual (e.g., corpora of field or topic specific documentation) or other inputs and labels as datasets to train determination, selection, or recognition of the ML models 190 for implementing DPS 120 functionalities (e.g., 130, 140 and 150). For instance, ML model trainer 180 can use datasets of interactions 142, elements 126 and adjusted content 162 to train generative AI models to arrange elements 126, produce element settings 152 or provide adjusted content 162. ML model trainer 180 can train ML models 190 using various data or interactions with content elements in user interfaces 160. For example, ML model trainer 180 can utilize data on interactions 142 with elements 126 in any application content 124 or adjusted content 162 of any applications 122 for a variety of client accounts 108 with any characteristics 132. ML model trainer 180 can train ML models 190 to detect or identify characteristics 132 using dataset with various arrangements, selections or ordering of interactions 142 and their relations with characteristics 132. ML model trainer 180 can train ML models 190 (e.g., generative AI or other types of models) using any application content 124 and any adjusted content 162 with any configuration or arrangement of elements 126. ML model trainer 180 can train ML models 190 using any dataset on relations between application content 124 and adjusted content 162 based on characteristics 132 for various client accounts and profiles 110 (e.g., various characteristics of various users). For instance, ML model trainer 180 can train ML models 190 to utilize a similarity search (e.g., cosine similarity or Euclidean distance) to find or identify text that provides a same or similar meaning with a different choice of words, such as for example to accommodate a characteristic 132 of a user that is unfamiliar with a particular sophisticated or specialized topic or field discussed in application content 124. For example, ML model trainer 180 can train an ML model 190 to use a sequence of interactions 142 to identify or detect characteristics 132 of a user. For example, ML model trainer 180 can train an ML model 190 to use various elements 126 of an original application content 124 to identify or detect the elements 126 to modify, rearrange or reconfigure to satisfy or accommodate a characteristic 132.

Data processing system (DPS) 120 can include any combination of hardware and software for providing an AI or ML-based computing architecture for customizing application-generated content to accommodate user based characteristics. DPS 120 can be implemented on one or more computing devices, such as a server, a server farm, or a cloud-based system, which can be executed using physical or virtual machines. DPS 120 can be configured or designed to detect and recognize user actions (e.g., interactions 142) and infer, detect, recognize, or determine user characteristics 132 based on the detected interactions 142. DPS 120 can be configured to recognize characteristics 132 based on user entries, such as entries of the user into the prompt of the user interface 160 asking questions the response to which can be indicative of characteristics 132. DPS 120 can be configured to utilize characteristics 132 associated with a client account 108 (e.g., of a user) to arrange elements 126 (e.g., based on element settings 152 that can be generated based on the characteristics 132) and provide adjusted content 162 with the rearranged, modified, adjusted, corrected, regenerated or otherwise arranged elements 126.

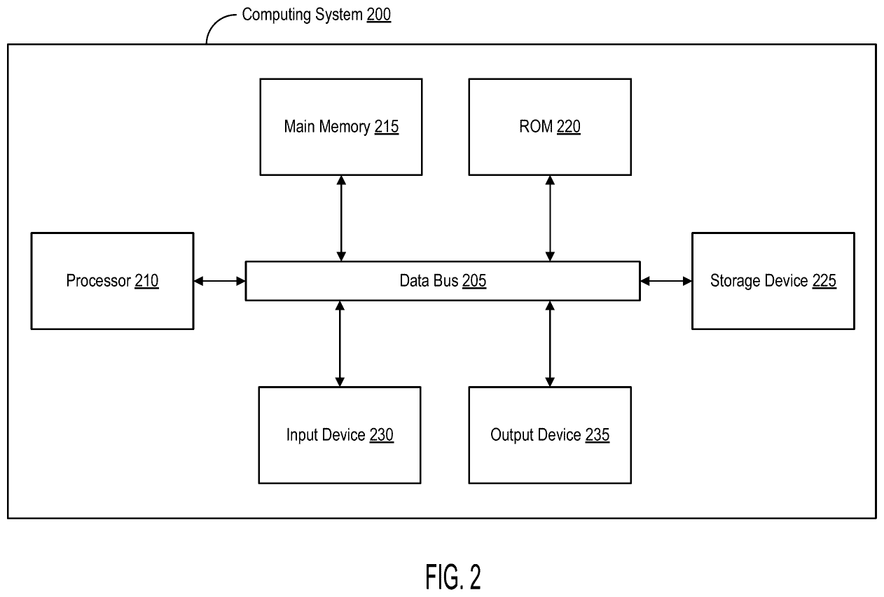

DPS 120 can be implemented using processors, such as a processor 210 in FIG. 2, that can be configured to implement the DPS functionality via computer code or instructions stored in memory (e.g., memory 215 of FIG. 2). DPS 120 can include an application executed on the DPS 120 and configured to provide to a client device 104 the functionality of the DPS 120 components. For instance, one or more processors 210 can be configured (e.g., programmed) to provide to client devices 104 an application that implements applications 122, characteristics identifiers 130, interactions detectors 140, elements arrangers 150, user interfaces 160 and ML models 190. For example, a processor 210 can be configured (e.g., via computer code instructions or data stored in memory 215) to implement any functionality or operation of an interactions detector 140, a characteristics identifier 130, an elements arranger or a user interface 160. For example, a client device 104 can utilize an application agent 106 to execute an application of the DPS 120, allowing the client device 104 to benefit from the DPS 120 functionality while accessing applications 122 providing application content 124.

User interface 160 can include any combination of hardware and software for providing or displaying content, such as application content 124 or adjusted content 162. User interface 160 can include a graphical user interface (GUI) that can include a visual interface using graphical elements, such as functional interfaces, buttons, menus, icons, sections of text, prompts or other functionalities to facilitate using interactions 142. User interface 160 can include a GUI that is configured to display, capture or record user interactions 142 with various elements 126. The user interface 160 can allow users to navigate, manipulate, and engage with the content (e.g., 124 or 162) in various ways, including via user selections, mouse clicks, usage of different applications, entries of various texts or characters or implementing various settings for viewing or hearing information or data. User interface 160 can be configured to display adjusted content 162 that can be generated by the DPS 120 based on user interactions 142 indicative of characteristics 132. User interface 160 can include or display web-based applications 122 or mobile applications 122 in accordance with any content layout, formatting, and presentation adapted to accommodate user characteristics 132.

For example, the user interface 160 can receive and present (e.g., display, play or provide) any content (e.g., elements 126) generated by any application 122. For instance, a DPS 120 can receive a first content (e.g., application content 124) for a human capital management (HCM) service, such as a payroll service, recruitment service, benefits service, retirement service, taxation service, or any other HCM service, to be displayed using a graphical user interface 160. The processor 210 can detect the elements 126 of the application content 124 generated by the application 122 responsive to a request associated with the client account 108. The request can be a request of a user to access the application 122 or provide the content 124 (e.g., click on a web page). The first content can be generated by an application 122 of the one or more applications 122 that can be associated with the client account 108 and displayed on the user interface 160. The user interface 160 can provide the elements 126 of the application content 124 and coordinate or facilitate the interactions detector 140 with detecting or capturing various interactions 142 on the elements 126 of the application content 124 to identify or detect characteristics 132. For instance, ML model trainer 180 can train an ML model 190 on interactions 142 in the user interface 160 with respect to any number of users of any number of profiles 110 in order to train or learn to identify or detect different types of characteristics 132 for a characteristics identifier 130.

Interactions detector 140 can include any combination of hardware and software for identifying, recognizing, determining, or detecting interactions 142. Interaction detector 140 can include any function for monitoring, detecting, or analyzing user behavior corresponding to, any interaction with or any pattern of engagement involving any portion of application content 124, such as elements 126 of the application content 124. Interactions detector 140 can include a functionality to follow a sequence of a plurality of user actions, such as a sequence of mouse movements or clicks, a sequence of web pages opened, a sequence of characters or words input into a search engine, identifying relationships or similarities between topics, phrases or words of the application content 124 and the search phrases. Interactions detector 140 can include one or more user selections, entries or actions taken in the user interface 160 in relation to or corresponding to the application content 124 or elements 126 of application content 124. Interactions detector 140 can utilize ML models 190 (e.g., generative AI, or other types of models) trained on user selections, inputs (e.g., input or mouse device movements) to detect or identify interactions 142. Interactions detector 140 can include or provide one or more commands, configurations, instructions, prompts or input settings for a ML model 190 to recognize, identify or determine interactions 142 from user actions taken with respect to application content 124 or its elements 126 in user interface 160.

The interactions detector 140 can detect one or more interactions 142 of the user with elements 126 of the application content 124. The application content 124 can be generated by one or more applications 122. For instance, applications 122 can include an application providing a payroll service (e.g., paycheck, employee benefits or tax preparation processing) to employees or contractors of an enterprise. The interactions 142 can be associated with a client account 108 or a profile 110 of the client account 108. For example, the interactions detector 140 can monitor one or more actions (e.g., interactions 142) of the user on a graphical user interface 160. The actions can include mouse clicks, menu selections, usage of applications or text entries associated with the application content 124. The actions can be taken with respect to elements 126 of the application content 124 generated by one or more applications 122 on the graphical user interface 160. For instance, the actions can include a series of mouse clicks to set up a font size or a volume level on a client device or an application. The actions can include a sequence of mouse clicks and character entries involving usage of a web browser to search a term from a text of the application content 124.

The interactions detector 140 can detect the one or more interactions 142 responsive to at least an action of the one or more actions input into the one or more models. For example, the interactions detector 140 can detect or identify an interaction 142 of the user with a setting of a client device 104 to increase the font size of the text. For example, the interactions detector can detect or identify an interaction 142 of the user with a setting of a volume of the sound of the speakers of the client device 104 or using a web-browser application 122 to search for a portion of text included in the application content 124 to determine the meaning of a phrase, field or a topic.

Characteristics identifier 130 can include any combination of hardware and software for identifying characteristics 132. Characteristics identifier 130 can include any function, computer code or instructions for recognizing characteristics 132 from interactions 142 in a user interface 160. Characteristics identifier 130 can analyze interactions 142 gathered by interactions detector 140 and determine corresponding characteristics 132. For example, characteristics identifier 130 can identify that a user has searched for terms of a text in a particular field and can determine that the user associated with the client account 108 is unfamiliar with that particular field. For example, characteristics identifier 130 can identify that a user has searched for terms of a text in a particular field and can determine that the user associated with the client account 108 is unfamiliar with that particular field. For example, characteristics identifier 130 can identify that a user associated with a client account 108 incorrectly spells particular words, incorrectly organizes sentences or text structure, and can determine that these actions are indicative of a dyslexia, which can be identified as a characteristic of the user. Characteristics identifier 130 can use any one or more interactions 142 and the sequences of interactions 142 to determine any one or more characteristics 132 of the user and store such characteristics 132 in profile 110 or a client account 108. Characteristics identifier 130 can utilize ML models 190 (e.g., generative AI, or other types of models) trained to determine characteristics 132 based on detected or identified interactions 142. For instance, characteristics identifier 130 can include one or more commands, configurations, instructions, prompts or input settings for a ML model 190 to recognize, identify or determine characteristics 132 from interactions 142.

The characteristics identifier 130 can identify the characteristic 132 based at least on the one or more interactions 142 that can be detected by the interactions detector 140. The one or more interactions 142 can be input into one or more ML models 190 (e.g., generative AI or other ML models) that can be trained with artificial intelligence or machine learning infrastructure on a plurality of interactions 142 with a plurality of elements 126 of content, such as application content 124 or adjusted content 162. The elements 126 can be indicative of a plurality of characteristics 132, such as medical or cognitive conditions (e.g., dyslexia, learning disability, inadequate language, or education levels for a particular type of context or text).

The characteristic identifier 130 can be configured to detect various types of characteristics 132 associated with a profile 110 of a client or a client account 108. For instance, the characteristic identifier 130 can detect, recognize, or identify a decay function. The decay function can correspond to an exponential decrease in a value or level of the characteristic. The level can be a numerical value or score, such as a numerical score in the range of 1 to 10, or 1 to 100, or any other scale. The decay function can include a function indicative of a level of a characteristic 132. For instance, the decay function can correspond to a characteristic 132 for an anxiety of a user, such as a level of anxiety of a user. The anxiety can be associated with or include an anxiety caused by stress of dealing with an unfamiliar field, topic, or textual content which the user does not understand due to insufficient training or education in the given field, language or area. The decay function can include or indicate one or more levels of a medical or a neurological condition (e.g., a moderate or a severe dyslexia), or one or more educational or training levels (e.g., a 7^{th} grade reading level, a low to moderate understanding of English language, a 40^{th} percentile in understanding complex or sophisticated texts in a particular field or topic). The decay function can have or identify a plurality of values indicative of plurality of levels of anxiety, visual or hearing impairment, or any other characteristic 132, which the user may experience.

The characteristics identifier 130 can change the characteristics 132 over time based on the changes to the decay function. The decay function can change over time indicative of changes to the characteristic 132 (e.g., the level or severity of the characteristic). For instance, a level of anxiety can be higher for newer topics at the start of the user's interactions with a particular topic or a field. The characteristics identifier 130 can detect, from the interactions 142, that the user's level of anxiety with respect to a given topic or a field or topic (e.g., tax related issues, payroll accounting questions or user-specific queries on health insurance) can be decreased over time as the user becomes increasingly familiar with the field or the topic (e.g., as the number of exposures of the user to the given topic or field increases). For instance, the characteristic identifier 130 can update the characteristic 132 based on the changes in the decay function over time, thereby changing the level of adjustments in the arrangement or modification of elements 126 in adjusted content 162 as the characteristic 132 is reduced over time. For instance, the characteristic identifier 130 can update the characteristic 132 to increase the characteristic severity (e.g., decay function value) in response to new information (e.g., detection of interactions 142) indicative of characteristic 132 becoming more severe.

Elements arranger 150 can include any combination of hardware and software for generating or creating adjusted content 162, such as an arrangement of elements 126 to accommodate identified user characteristics 132. Elements arranger 150 can include any function, computer code or instructions for deriving, creating, adjusting, or editing elements 126 of the original application content 124 in order to accommodate characteristics 132 with the adjusted content 162. Elements arranger 150 can include the functionality for using element settings 152 to convert, configure or arrange elements 126 of the application content 126 according to the characteristics 132. Elements arranger 150 can include one or more commands, configurations, instructions, prompts or input settings for a ML model 190 to generate an arrangement of elements 126 (e.g., an adjusted content 162).

Elements arranger 150 can include any function, computer code or instructions for creating element settings 152 for conversion of application content 124 into adjusted content 162. Element setting 152 can include any combination of instructions, data, and parameters for converting, adjusting, modifying, reconfiguring, rearranging or arranging elements 126 according to, or to accommodate, a characteristic 132. Element settings 152 can include instructions, commands, or parameters for rearranging or reconfiguring elements 126 to produce adjusted content 162 satisfying the characteristic 132. Elements settings 152 can include, be implemented by, or utilize ML models 190 (e.g., generative AI, or other types of models) trained to generate new arrangements of elements 126 (e.g., adjusted content 162) based on original application content 124 (e.g., original arrangement of the same or different elements 126) and the characteristics 132. Element settings 152 can include a configuration, a prompt or input settings for a ML model 190 to generate an arrangement of elements 126 of the adjusted content 162 corresponding to the characteristics 132.

The elements arranger 150 can utilize thresholds for determining if the content (e.g., application content 124 or adjusted content 162) to be displayed for a user on a user interface 160 is according to, conforms to or otherwise accommodates one or more characteristics 132. The threshold can include a threshold to determine if the content (e.g., application content 124 or adjusted content 162) is to be further processed, configured, or adjusted by the elements arranger 150, or if it can be provided to the user interface 160 in its current form. The elements arranger 150 can utilize characteristics identifier 130 to evaluate the thresholds or can make the threshold related determinations together with the characteristics identifier 130. The threshold can be used by the characteristics identifier 130 or the elements arranger 150 to determine if the elements 126 of application content 124 generated by an application satisfies, conforms to, or accommodates the accommodate characteristics 132 associated with a profile 110 of a client account 108. In some implementations, the threshold for the characteristic 132 can be a threshold that the application content 124 is not be satisfied in order for the content to be displayed on the user interface 160. In some implementations, the threshold for the characteristic 132 can be a threshold that the application content 124 is to be satisfied prior to displaying the content on the user interface 160.

For instance, the elements arranger 150 can determine that the first content (e.g., application content 124 generated by an application 122) corresponds to a particular (e.g., first) word count. The elements arranger 150 can determine that word count of the application content 124 satisfies a threshold for a characteristic 132 that corresponds to a word count. Based on the determination that the threshold is satisfied, the elements arranger 150 can determine that the application content 124 generated by an application 122 does not satisfy the characteristic 132 and is to be adjusted or processed by elements arranger 150 prior to it being displayed by the user interface. For example, if a determination is made that a threshold corresponding to the content is satisfied (e.g., a value corresponding to the content exceeds or falls below the threshold), the elements arranger 150 can determine that the content is to be adjusted or processed by elements arranger 150 in order to conform the content to the characteristic 132. In some implementations, the elements arranger 150 can determine that the content is to be adjusted or processed by elements arranger 150 in order to conform the content to the characteristic 132 responsive to determining that a threshold corresponding to the content is not satisfied.

The elements arranger 150 can determine if the application content 124 satisfies a threshold by using one or more ML models 190 (e.g., generative AI or other models) trained to detect or determine whether the threshold is satisfied for each particular characteristic 132 of the client profile 110. For example, the elements arranger 150 can apply the application content 124 to the element settings 152 generated for the characteristic 132 (e.g., using a ML model 190 or element settings 152 function or code) and determine if the threshold is satisfied. For instance, the threshold for the word count can indicate an amount of text (e.g., number of words) that is too large for a user associated with the client account 108 to handle, given the user's level of education, training, types of tasks assigned or a role that the user serves in the organization. The threshold for a characteristic 132 can include, for example, the threshold for an acceptable number of words in the text. Such a threshold can be used to trigger an elements arranger 150 make a correction to the text according to a word count that satisfies the threshold, such as by rewriting the text (e.g., using an ML model 190) to generate a summary of the text with a word count that is below the threshold for the word count.

For instance, the elements arranger 150 can determine that the first content (e.g., application content 124 generated by application 122) satisfies a threshold for the characteristic 132 that corresponds to visual impairment of the user. The threshold for visual impairment can include, for example, the size of the features (e.g., text or images) on the display in reference to a predetermined size of the features that conform to the user's visual impairment characteristic. For instance, the user may have a difficulty seeing the text (e.g., elements 126) on the user interface 160. The characteristics identifier 130 can detect that interactions detector 140 has detected a series of actions (e.g., an interaction 142) with settings for a zoom for the content or text, indicative of the characteristic 132 of visual impairment. For instance, the elements arranger 150 can determine that the first content (e.g., application content 124 generated by application 122) satisfy or does not satisfy a threshold for the characteristic 132 that corresponds to hearing impairment of the user. For instance, the elements arranger 150 can detect that interactions detector 140 has detected a series of actions (e.g., an interaction 142) with settings for sound, indicative of the characteristic 132 of hearing impairment.

For instance, the elements arranger 150 can determine that the first content (e.g., application content 124 generated by application 122) satisfies a threshold for the characteristic 132 corresponding to a level of literacy. The threshold for the level of literacy can include a threshold for the level of complexity of the text or the size of the text, the number of sophisticated or field-specific phrases, words, or concepts. For instance, the elements arranger 150 can determine that the application content 124 satisfies a threshold for the characteristic corresponding to a level of proficiency in a field or a level of education that exceeds the level of proficiency or the level of education of the user. Responsive to such determinations that the threshold is satisfied, the elements arranger 150 can adjust the content (e.g., modify, adjust, regenerate, reorder or otherwise arrange the elements 126) to generate the adjusted content 152 that does not satisfy the thresholds (e.g., the level of literacy or the level of proficiency in a field or a level of education of the user). In implementations in which the logic is reversed, the responsive to determination that the threshold is not satisfied (e.g., to accommodate the characteristic), the elements arranger 150 can adjust the content to arrange the elements 126 to generate the adjusted content 152 that satisfies the threshold (e.g., the level of literacy or level of proficiency or level of education or any other level for satisfying a characteristic). For instance, the elements arranger 150 can regenerate the texts, multimedia, portions of the user interface 160 or other aspects of the content, using ML models 190 to have the same or similar messages or ideas expressed in a simpler language that does not satisfy the thresholds (e.g., the content sufficiently accommodates the characteristics 132).

The elements arranger 150 can include any functionality to detect or determine any thresholds for content that does not accommodate neurocognitive challenges of the user. For instance, elements arranger 150 can detect thresholds for detecting whether the application content 124 does not accommodate any one or more of: attention deficit hyperactivity disorder (ADHD), dyslexia, autism spectrum disorder (ASD), intellectual disability (ID), specific language impairment (SLI), nonverbal learning disorder (NVLD) and visual processing disorder (VPD). These thresholds can include, for example, determinations (e.g., using ML models 190 implemented using generative AI techniques) on the type of text that is difficult to understand for the people with a given level of neurocognitive disability or a challenge. For instance, an ML model 190 can be trained to detect that application content 124 includes text (e.g., mathematical formulas, instructions on payroll or taxation or other information) that is difficult for a person with a particular level of ADHD or dyslexia to understand. Responsive to this determination, the elements arranger 150 can adjust, reorder, or otherwise arrange the elements 126 of the application content 124 to no longer satisfy the thresholds that trigger the elements arranger 150 to generate the adjusted content 162 (e.g., arrange the elements 126).

For example, the elements arranger 150 can determine elements 126 to form, adjust, correct, or otherwise configure based on the original application content 124 and determine arrangement of such elements 126 in the adjusted content 162 to be presented instead of the originally generated application content 124. For instance, a processor 210 can execute an elements arranger 150 to generate, based at least on the first content from the application 122, an arrangement of elements 126 according to the characteristic 132. For example, the arrangement of elements 126 can generate elements 126 or produce an adjusted content 162 that satisfies one or more conditions (e.g., thresholds) for accommodating the characteristic 132.

For example, the elements arranger 150 can generate a second content (e.g., adjusted content 162) that can include the arrangement of elements 126 of the first content (e.g., 124). The arrangement (e.g., rearrangement, ordering, reordering, adjustment, recreation, regeneration, or modification) of elements 126 based at least on a setting for the arrangement of elements (e.g., element setting 152) that is associated with the characteristic 132. The element setting 152 can include a configuration of instructions, computer code or data to convert application content 124 so that the produced adjusted content 162 does not satisfy a threshold for further arrangement (e.g., further adjustment or modification) of elements 126, but instead satisfies the thresholds and can be served to the user via the user interface 160.

For example, the elements arranger 150 can generate at least one of the arrangement of elements or the second content using the one or more models (e.g., ML models 190) that are trained with machine learning in the first language and the second language. For example, a generative AI model can be trained to modify elements 126 of the original application content 124 to generate a new arrangement of elements 126 which can individually be adjusted, modified, or regenerated to conform to a particular characteristic 132. For instance, the elements arranger 150 can trigger or instruct an ML model 190 (e.g., an NPL model trained to translate text between languages) to convert the application content 124 from a first language into the second or vice versa, modifying words, phrases, or sentences to provide the adjusted content 162.

For example, the elements arranger 150 can generate, responsive to the characteristic, a setting for the arrangement of elements (e.g., element setting 152) to accommodate the characteristic 132. For instance, the elements arranger 150 can use an element setting 152 to convert elements 126 of application content 124 into elements 126 of adjusted content 162. The elements setting 152 can be configured to adjust, generate, create, or modify elements 126 of the application content 124 into elements 126 that no longer satisfy the thresholds that trigger further processing, arrangement or adjustment to the content. The elements arranger 150 can generate, create, or adjust the element setting 152 and can store the element setting 152 into a data repository 170, along with, or in association with, a profile 110 of the account 108. The profile 110 can include one or more element settings 152 for one or more characteristics 132 associated with a profile 110 of a user or a client account 108.

The elements arranger 150 can communicate with or utilize a characteristics identifier 130 to provide content adjustment. For example, the characteristics identifier 130 can detect, based at least on a portion of the first content (e.g., 124) input into the one or more ML models 190, that the portion of the first content (e.g., 124) corresponds to the characteristic 132. The elements arranger 150 can generate, responsive to the detection by the characteristics identifier 130, the arrangement of elements 126 using the one or more ML models 190 and the portion of the first content (e.g., 124) that is used as the input into the ML model 190.

The elements arranger 150 can determine that the first content (e.g., 124) corresponds to a value of a decay function that satisfies a threshold for the characteristic corresponding to anxiety. In response to satisfying the threshold, the elements arranger 150 can determine that the application content 124 generated by the application 122, in its current form, will trigger or cause the user to feel anxiety. The elements arranger can generate, responsive to the determination, the arrangement of elements 126 that correspond to a second value (e.g., threshold) of the decay function that does not satisfy the threshold for the characteristic.

For instance, responsive to the elements arranger 150 determining that the first content corresponds to a first word count that satisfies a threshold for the characteristic corresponding to the word count, the elements arranger 150 can generate the arrangement of elements 126 corresponding to a second word count that does not the threshold for the characteristic 132 (e.g., that accommodates the characteristic 132). The elements arranger 150 can make such determinations and provide the arranged elements 126 using one or more ML models 190 trained to recognize or evaluate the thresholds and generating the content. For instance, the elements arranger 150 can identify that the first content is written in a first language and identify that the characteristic 132 corresponds to a second language with which the user is more familiar or in which the user is more fluent or educated. The elements arranger can generate, based at least one the first content, the arrangement of elements 126 of a second content (e.g., adjusted content 162) corresponding to the first content (e.g., application content 126) and written or rewritten in the second language.

For example, the elements arranger 150 can determine that the first content (e.g., application content 124) satisfies a threshold for the characteristic 132 (e.g., does not conform to the characteristic 132) corresponding to visual impairment. The elements arranger 150 can generate, responsive to this determination, the arrangement of elements 126 that does not satisfy the threshold. For instance, the elements arranger 150 can reset the user interface 160 to a larger zoom format, allowing the user to see the text more visibly, thereby accommodating the user characteristic 132 and no longer triggering the threshold for content adjustment. For instance, the elements arranger 150 can utilize an ML model 190 to rewrite the text using a fewer number of words, to allow the user to fit the text into a smaller surface area.

For instance, the elements arranger 150 can determine that the first content satisfies a threshold for the characteristic corresponding to at least one of a visual impairment or a hearing impairment. The elements arranger 150 can generate, responsive to the determination, the arrangement of elements to be sounded over a speaker according to a volume. For example, the output may have been visual only, whereas the data processing system 120 can provide a voice-overlay in addition to the visual output. For instance, the elements arranger 150 can set the volume of the speakers of the client device 104 to a higher level, thereby allowing the user to more clearly hear the sound being played (e.g., text being read out).

For instance, responsive to determining that the first content satisfies a threshold for the characteristic 132 corresponding to a neurocognitive challenge, the elements arranger 150 can generate the arrangement of elements 126 that does not satisfy the threshold (e.g., the arrangement of elements 126 or adjusted content 162 that accommodates the neurocognitive challenge of the user or allows the user with that neurocognitive challenge to understand and benefit from the content provided). For instance, responsive to determining that the first content (e.g., 124) satisfies a threshold for the characteristic corresponding to a level of literacy, the elements arranger 150 can generate the arrangement of elements 126 that does not satisfy the threshold (e.g., generates the text that is within or conforms to the level of literacy of the user). For example, responsive to determining that the first content (e.g., 124) satisfies a threshold for the characteristic corresponding to a level of proficiency in a field, the elements arranger 150 can the arrangement of elements 126 that does not satisfy the threshold (e.g., generates the text that corresponds to the level of proficiency of the user in the given field). For example, the elements arranger 150 can utilize a ML model 190 to rewrite the text using simpler or more widely known words and explaining technical concepts in a more commonly understood language or inserting into the text links to web pages providing the relevant explanation, allowing the user to understand the meaning of the terms). Once the adjusted content 162 is generated such that it does not trigger the thresholds for the characteristics 132, the processor 210 can cause the graphical user interface (e.g., 160) to display the arrangement of elements 126 for the user.

FIG. 2 illustrates a block diagram of a computing system 200 for implementing the embodiments of the present solution, in accordance with embodiments. FIG. 2 illustrates a block diagram of an example computing system 200, which can also be referred to as the computer system 200. Computing system 200 can be used to implement elements of the systems and methods described and illustrated herein, such as for example, commands, instructions or data described herein. Computing system 200 can be included in, provide support for, or run any device (e.g., client or a user device 104, DPS 120), or any other feature or component described herein.

Computing system 200 can include at least one bus data bus 205 or other communication device, structure or component for communicating information or data. Computing system 200 can include at least one processor 210 or processing circuit coupled to the data bus 205 for executing instructions or processing data or information. Computing system 200 can include one or more processors 210 or processing circuits coupled to the data bus 205 for exchanging or processing data or information along with other computing systems 200. Computing system 200 can include one or more main memories 215, such as a random access memory (RAM), dynamic RAM (DRAM), cache memory or other dynamic storage device, which can be coupled to the data bus 205 for storing information, data and instructions to be executed by the processor(s) 210. Main memory 215 can be used for storing information (e.g., data, computer code, commands, or instructions) during execution of instructions by the processor(s) 210.

Computing system 200 can include one or more read only memories (ROMs) 220 or other static storage device 225 coupled to the bus 205 for storing static information and instructions for the processor(s) 210. Storage devices 225 can include any storage device, such as a solid state device, magnetic disk, or optical disk, which can be coupled to the data bus 205 to persistently store information and instructions.

Computing system 200 may be coupled via the data bus 205 to one or more output devices 235, such as speakers or displays (e.g., liquid crystal display or active matrix display) for displaying or providing information to a user. Input devices 230, such as keyboards, touch screens or voice interfaces, can be coupled to the data bus 205 for communicating information and commands to the processor(s) 210. Input device 230 can include, for example, a touch screen display (e.g., output device 235). Input device 230 can include a cursor control, such as a mouse, a trackball, or cursor direction keys, for communicating direction information and command selections to the processor(s) 210 for controlling cursor movement on a display.

The processes, systems and methods described herein can be implemented by the computing system 200 in response to the processor 210 executing an arrangement of instructions provided via main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors 210 in a multi-processing arrangement may also be employed to execute the instructions contained in main memory 215. Hard-wired circuitry can be used in place of or in combination with software instructions together with the systems and methods described herein. Systems and methods described herein are not limited to any specific combination of hardware circuitry and software.

Although an example computing system has been described in FIG. 2, the subject matter including the operations described in this specification can be implemented in other types of digital electronic circuitry, or in computer software, firmware, or hardware, including the structures disclosed in this specification and their structural equivalents, or in combinations of one or more of them.

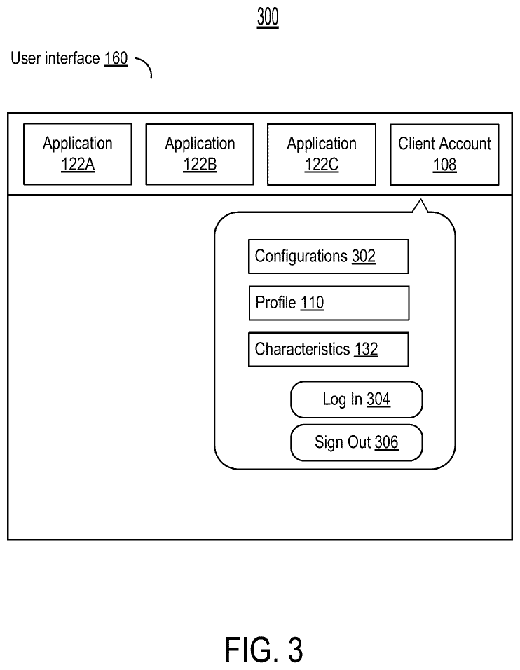

FIG. 3 illustrates an example of an output 300 of a user interface 160 for providing an access to a client account 108 to allow setting up of user configurations, profile and characteristics. The example output 300 can include or correspond to a screenshot of a user interface 160 allowing a user to access an application allowing the user to utilize the functionalities of a DPS 120. The user interface 160 can provide a user prompt with links or buttons for a variety of applications 122, including applications 122A, 122B and 122C. The user interface can provide a link or a button for a client account 108.

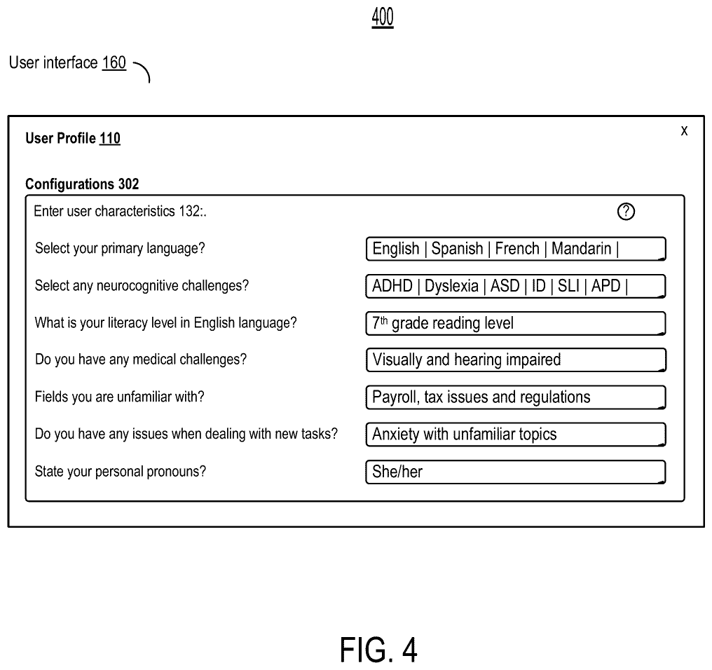

Upon clicking on the client account 108 button, the user can gain access to various windows for setting the application for utilizing the functionalities of the DPS 120. For instance, the user can gain access to windows or prompts for configurations 302, profile 110 and characteristics 132. For instance, the user can access a button for a log in 304 function. The log in 304 can allow the user to provide credentials and log into the application providing the functionalities of the DPS 120 (e.g., application utilizing interactions detector 140, characteristics identifier 130, elements arranger 150 and the user interface 160). The user can also access sign out 306 function which can allow the user to sign out of the application. The configurations 302 can include a link or a button to one or more windows allowing the user to configure the user's information, such as access or personal information. The user can access the profile 110 and edit any information or functionalities of the profile 110. The user can also access the characteristics 132 and enter, provide, edit, or update any characteristics 132 or any information corresponding to or relating characteristics 132, such as for example, shown in FIG. 4.

FIG. 4 is an example 400 of an output of a user interface 160 for updating a user profile 110 and providing configurations or information about characteristics 132. In example output 400, the user interface 160 can provide a window for a user profile 110 including configurations 302 prompt for configuring user characteristics 132. Using the configurations 302 in the user interface 160, the user can enter, specify, and provide details or data that can be used by the DPS 120. Configuration 302 can prompt the user to provide information that can be indicative or descriptive of any characteristics 132 that can be associated with the profile 110 of the client account 108 (e.g., user characteristics).

For instance, configurations 302 can prompt the user about the user's primary language, or any other languages the user may be familiar with. The configurations 302 can prompt the user about the level of fluency of the user in any of the languages, allowing the characteristics identifier 130 to determine, identify or detect any characteristics 132 from the information provided. For instance, the characteristics identifier 130 can determine thresholds for various types of content based on the level of fluency of the user in any of the languages in which the content may be provided.

For instance, configurations 302 can prompt the user about any neurocognitive challenges or neurodiversity related challenges. The user may input information about, or select from a selection on, various neurocognitive or neurodivergent attributes or difficulties, such as ADHD, dyslexia, OCD, dyscalculia, dysgraphia, ASD, ID, SLI, APD. The user can provide information about any levels or ratings concerning any of the challenges (e.g., mild, moderate, or severe). The characteristics identifier 130 can determine characteristics 132 or thresholds for any of the characteristics, based on the input data.

For instance, configurations 302 can prompt the user to input information on the level of literacy of the user, reading skills, information about visual or hearing impairment, fields or topics the user may be familiar or not familiar with, any information on anxiety in connection with dealing with unfamiliar topics, personal pronouns (e.g., she/her, he/him, they/them), any of which can be used by the characteristics identifier 130 to determine any of the characteristics 132 or determine any thresholds for detecting content to be modified according to the characteristics 132.

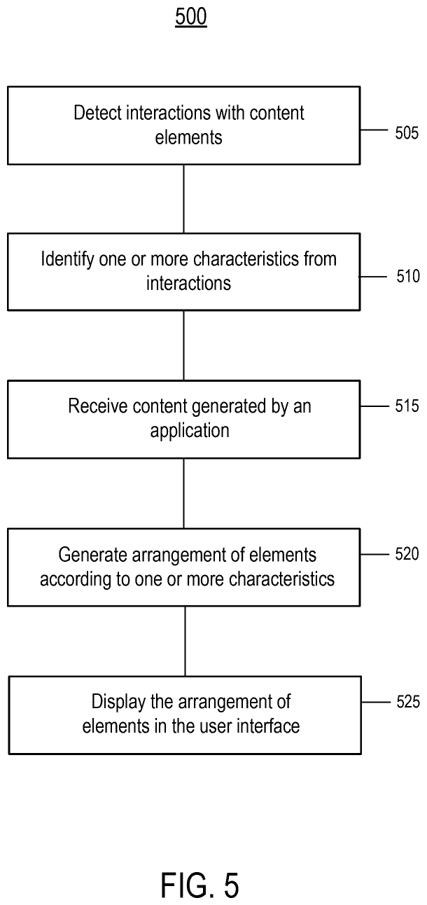

FIG. 5 illustrates a flow diagram of a method 500 for identifying user characteristics from user interactions and customizing application-generated content according to identified user characteristics. The method 500 can be performed by one or more systems or components depicted in FIGS. 1-4, including, for example, a data processing system 120 of FIG. 1 implemented using processors 210 configured to perform the functionalities of the DPS 120 based on instructions, computer code or data stored on memory or storage (e.g., 215, 220 or 225) of a computing system 200. At a high level, method 500 can include acts 505-525. At 505, the method can include identifying interactions with content elements. At 510, the method can include identifying one or more characteristics based on the interactions. At 515, the method can include receiving content generated by an application. At 520, the method can include generating arrangement of elements according to the one or more characteristics. At 525, the method can include displaying the arrangement of elements in the user interface.

At 505, the method can include identifying interactions with content elements. The method can include one or more processors coupled with memory and configured to detect one or more interactions in a user interface. For example, the method can include the interactions detector detecting one or more interactions with elements of content generated by one or more applications. The one or more interactions associated with an account associated with a user. The interactions detector can detect a series of actions, such as movements of a mouse, selections of menu options or entering of one or more characters via a keyboard. The interactions can be indicative of particular actions taken by the user, such as actions indicative of one or more characteristics.

For example, the interactions detector can detect that a user is interacting with the content to determine the meaning of some words, phrases or concepts provided in the user interface. The words, phrases or concepts can be associated with a particular language, a particular level of education or training or a particular field or a topic (e.g., tax laws, determination of wages or employment bonuses, issues relating health insurance, or other topics). The interactions can include a combination or arrangement of user actions indicative of the user searching for the meaning of the words, phrases or concepts using internet searching engines.

The interactions detector can monitor one or more actions of the user on elements of content. The interactions detector can monitor mouse clicks, menu selections, usage of particular applications (e.g., web browser), particular functions or websites or particular activities (e.g., using search engines). The interactions detector can utilize machine learning (ML or AL) models to detect interactions from various user inputs or actions taken on the user interface. The interactions detector can monitor user interactions with any content generated by one or more applications on the graphical user interface, such as textual content, multimedia content or any application output content.

At 510, the method can include identifying one or more characteristics based on the interactions. The method can include the one or more processors identifying a characteristic associated with the account. For instance, a characteristics identifier can identify the characteristics based at least on the one or more interactions input into one or more models trained with machine learning on a plurality of interactions with a plurality of elements of content that can be indicative of a plurality of characteristics. For example, a characteristics identifier can utilize any number of ML models, such as generative AI models, trained on any number of characteristics of any number of users. The ML models can be configured or trained to identify characteristics associated with the user, based on a pattern of interactions of the user with particular elements of application content displayed in the user interface.

For example, a generative AI model can be configured to detect or identify any characteristics associated with a profile or a client account. The characteristics identified can include, for example, challenges or limitations involving a level of education of the user, language preferences, level of literacy, fields, or topics with which the user is unfamiliar or unsophisticated, fields or topics that cause anxiety to the user, or any neurological or medical limitations. For example, characteristics can include neurocognitive challenges, such as: attention deficit hyperactivity disorder (ADHD), dyslexia, autism spectrum disorder (ASD), intellectual disability (ID), specific language impairment (SLI), nonverbal learning disorder (NVLD) and visual processing disorder (VPD). For example, characteristics can include medical challenges, such as impaired vision or hearing.

The one or more processors can generate, responsive to the characteristic, a setting for the arrangement of elements to accommodate the characteristic. For example, the characteristics identifier or the elements arranger can generate an element settings for each identified characteristic. The elements settings can be used to convert application content that does not accommodate characteristics into adjusted content with arranged elements that accommodates the characteristics. The one or more processors can store the setting into a profile of the account. For instance, the profile can include one or more settings for the one or more characteristics. For example, the profile associated with an account can include one or more element settings for each of the characteristics, allowing for example, ML models convert content to accommodate or satisfy the characteristics.

For example, an interactions detector can detect the one or more interactions responsive to at least an action of the one or more actions input into the one or more models. The interactions identifier or the characteristics identifier can utilize one or more ML models (e.g., generative AI or other models) trained to monitor actions or user interactions with the content in the user interface to discern, detect, recognize, or determine interactions that are indicative of one or more characteristics. For example, an ML model can monitor user interactions with web browser in which a user can insert a portion of text from an application content to search the meaning of the portion of the text. The ML model can determine, responsive to such monitoring, that the portion of the text concerns a topic, a field or type of language (e.g., specialized phrases or content) that are unfamiliar to the user. For example, an ML model can detect that the user searches for meaning of the words in the English language (e.g., or any other language) and can determine that the user has a limited understanding of the language. For example, an ML model can detect that the user is misspelling the words and writes text out of order and can determine that the user is dyslexic. For example, an ML model can detect any arrangement of interactions in the user interface, and determine based on the interactions, that the particular characteristic is associated with the account.

At 515, the method can include receiving content generated by an application. The method can include the one or more processors receiving a first content for a payroll service to be displayed using a graphical user interface. The method can include the one or more processors detecting elements of the first content generated by the application responsive to a request associated with the account. The first content can be generated by an application of the one or more applications associated with the account. For example, one or more applications executed on a client device or a DPS can generate application content responsive to a request (e.g., a click or a prompt) of the user for the application content. The content can include any payroll content, such as a content of an application for processing wages or payments for employees of an enterprise, an application for managing health insurance, an application for conforming to regulations for a business enterprise or an application for processing payments or taxes corresponding to the enterprise.

The application content can be received by an elements arranger. The elements arranger can process the content to determine if the content triggers any thresholds for adjusting the content to accommodate any characteristics. For example, the elements arranger can apply the received content to element settings to determine if the application content conforms to the characteristics. The elements arranger can evaluate the application content using, for example, element settings for each of the characteristics of the user and one or more ML models trained for the characteristics.

At 520, the method can include generating arrangement of elements according to the one or more characteristics. The method can include the one or more processors generating, based at least on the first content, an arrangement of elements according to the characteristic. The method can utilize ML models, such as generative AI models, to construct or create any combination of adjusted or new elements and the new arrangement of such elements to produce the adjusted content. For example, the elements arranger can apply a first element setting evaluation of the application content according to a first characteristic with one or more ML models trained for the type of the characteristic corresponding to the first characteristic (e.g., a neurological challenge, a literacy level, a level of education, an anxiety level with respect to a particular field or content or a medical challenge). Responsive to at least one or more of a portion of the generated application content or an element settings for a particular characteristic input into one or more ML models trained for detecting one or more characteristics, the elements arranger can generate an adjusted content with an arrangement of elements that accommodates the characteristic.

The elements arranger can generate a second content (e.g., adjusted content) comprising the arrangement of elements of the first content (e.g., application content) based at least on a setting for the arrangement of elements associated with the characteristic, such as an element setting for a particular characteristic. For example, the elements setting can include a computer code, instructions or prompts that can configure or customize an ML model (e.g., an NPL or a GPT model) to adjust an input application content in a manner that accommodates a particular characteristic.

The method can include the elements arranger detecting, based at least on a portion of the first content input into the one or more models, that the portion of the first content (e.g., application content) corresponds to the characteristic. The elements arranger can generate, responsive to the detection, the arrangement of elements using the one or more ML models and the portion of the first content (e.g., application content). For instance, the elements arranger can identify that a portion of the application content satisfies a threshold triggering generating of an adjusted content to satisfy a particular characteristic. Responsive to the threshold being satisfied, the elements arranger can input the portion of the application content into the ML model to generate the adjusted content with the arrangement of elements that does not trigger the threshold for further adjustment.

The method can include the elements arranger identifying a decay function for the characteristic corresponding to anxiety. For instance, the decay function can include a function that changes over time (e.g., reduces) as the user becomes more familiar with particular topics. The elements arranger can determine that the first content (e.g., application generated content) corresponds to a value of the decay function that satisfies a threshold for the characteristic corresponding to anxiety. For example, the value determined by a ML model on an application content can determine that the application content exceeds the level of sophistication or difficulty exceeding the user's level of comfort with a field or topic. The method can include generating, responsive to the determination, the arrangement of elements that corresponds to a second value of the decay function that does not satisfy the threshold for the characteristic (e.g., accommodates the characteristic and reduces anxiety by making the content more understandable).

The method can include the elements arranger determining that the first content corresponds to a first word count that satisfies a threshold for the characteristic corresponding to the word count. The elements arranger can generate, responsive to the determination, the arrangement of elements corresponding to a second word count that does not satisfy the threshold for the characteristic. The method can include the element arranger identifying that the first content is written in a first language. The method can include identifying that the characteristic corresponds to a second language and generating, based at least one the first content, the arrangement of elements of a second content corresponding to the first content and written in a second language. The method can include generating at least one of the arrangement of elements or the second content using the one or more models trained with machine learning in the first language and the second language.

The method can include the elements arranger determining that the first content satisfies a threshold for the characteristic corresponding to visual impairment. The method can include the elements arranger generating, responsive to the determination, the arrangement of elements that does not satisfy the threshold. The method can include the elements arranger determining that the first content satisfies a threshold for the characteristic corresponding to at least one of a visual impairment or a hearing impairment. The elements arranger can generate, responsive to the determination, the arrangement of elements to be sounded over a speaker according to a volume level that does not satisfy the threshold.

The method can include the element arranger determine that the first content satisfies a threshold for the characteristic corresponding to a neurodiversity or neurocognitive challenge and generate, responsive to the determination, the arrangement of elements that does not satisfy the threshold. The neurocognitive or neurodiverse challenge can include any one or more of: ADHD, ADD, dyslexia, autism, ASD, ID, SLI, NVLD, Tourette, obsessive-compulsive disorder, dyscalculia, dysgraphia, dyspraxia, intellectual disabilities, Prader-Willi syndrome, bipolar disorder, social anxiety, Williams syndrome, sensory processing disorders and VPD. The method can include the elements arranger determining that the first content satisfies a threshold for the characteristic corresponding to a level of literacy and generating, responsive to the determination, the arrangement of elements that does not satisfy the threshold. The method can include the elements arranger determining that the first content satisfies a threshold for the characteristic corresponding to a level of proficiency in a field and generating, responsive to the determination, the arrangement of elements that does not satisfy the threshold.

At 525, the method can include displaying the arrangement of elements in the user interface. The method can include the one or more processors triggering displaying of the arrangement of elements on the graphical user interface. The method can include a user interface, such as a graphical user interface, displaying the arrangement of elements of the adjusted content. The method can include the graphical user interface displaying the arrangement of elements responsive to the determination of the elements arranger that the arrangement of elements of the adjusted content does not satisfy a threshold for a characteristic. The method can include providing for display, on the graphical user interface, the arrangement of elements responsive to the second value of a decay function not satisfying the threshold, the second value of the decay function corresponding to adjusted content generated to address an anxiety characteristic.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be a cloud storage product or service, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses.

Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computer device”, “component” or “data processing system” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, a computer system 200 described in FIG. 2 can be used in conjunction with, instead of, or together with system 100 or its system components, and vice versa. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising one or more processors coupled with memory to:
detect one or more interactions with elements of content generated by one or more applications, the one or more interactions associated with an account;
identify, based at least on the one or more interactions input into one or more models trained with machine learning on a plurality of interactions with a plurality of elements of content indicative of a plurality of characteristics, a characteristic associated with the account;
receive a first content for a payroll service to be displayed using a graphical user interface, the first content generated by an application of the one or more applications associated with the account;
generate, based at least on the first content, an arrangement of elements according to the characteristic; and
display, on the graphical user interface, the arrangement of elements.

2. The system of claim 1, comprising the one or more processors to:
detect elements of the first content generated by the application responsive to a request associated with the account;
generate a second content comprising the arrangement of elements of the first content based at least on a setting for the arrangement of elements associated with the characteristic; and
display, on the graphical user interface, the second content responsive to the request.

3. The system of claim 1, comprising the one or more processors to:
generate, responsive to the characteristic, a setting for the arrangement of elements to accommodate the characteristic; and
store the setting into a profile of the account, the profile including one or more settings for one or more characteristics.

4. The system of claim 1, comprising the one or more processors to:
detect, based at least on a portion of the first content input into the one or more models, that the portion of the first content corresponds to the characteristic; and
generate, responsive to the detection, the arrangement of elements using the one or more models and the portion of the first content.

5. The system of claim 1, comprising the one or more processors to:
monitor one or more actions on elements of content generated by the one or more applications on the graphical user interface; and
detect the one or more interactions responsive to at least an action of the one or more actions input into the one or more models.

6. The system of claim 1, comprising the one or more processors to:
identify a decay function for the characteristic corresponding to anxiety;
determine that the first content corresponds to a value of the decay function that satisfies a threshold for the characteristic corresponding to anxiety;
generate, responsive to the determination, the arrangement of elements that corresponds to a second value of the decay function that does not satisfy the threshold for the characteristic; and
provide for display, on the graphical user interface, the arrangement of elements responsive to the second value.

7. The system of claim 1, comprising the one or more processors to:
determine that the first content corresponds to a first word count that satisfies a threshold for the characteristic corresponding to the word count; and
generate, responsive to the determination, the arrangement of elements corresponding to a second word count.

8. The system of claim 1, comprising the one or more processors to:
identify that the first content is written in a first language;
identify that the characteristic corresponds to a second language; and
generate, based at least on the first content, the arrangement of elements of a second content corresponding to the first content and written in a second language.

9. The system of claim 8, comprising the one or more processors to generate at least one of the arrangement of elements or the second content using the one or more models trained with machine learning in the first language and the second language.

10. The system of claim 1, comprising the one or more processors configured to:
determine that the first content satisfies a threshold for the characteristic corresponding to visual impairment; and
generate, responsive to the determination, the arrangement of elements that does not satisfy the threshold.

11. The system of claim 1, comprising the one or more processors configured to:
determine that the first content satisfies a threshold for the characteristic corresponding to at least one of a visual impairment or a hearing impairment; and
generate, responsive to the determination, the arrangement of elements to be sounded over a speaker according to a volume setting.

12. The system of claim 1, comprising the one or more processors configured to:
determine that the first content satisfies a threshold for the characteristic corresponding to a neurocognitive challenge; and
generate, responsive to the determination, the arrangement of elements that does not satisfy the threshold.

13. The system of claim 12, wherein the neurocognitive challenge includes at least one of:
attention deficit hyperactivity disorder (ADHD), dyslexia, autism spectrum disorder (ASD), intellectual disability (ID), specific language impairment (SLI), nonverbal learning disorder (NVLD), Tourette syndrome, obsessive-compulsive disorder, down syndrome, dyscalculia, dysgraphia, dyspraxia, intellectual disabilities, mental health conditions, Prader-Willi syndrome, sensory processing disorders, social anxiety, Williams syndrome and visual processing disorder (VPD).

14. The system of claim 1, comprising the one or more processors configured to:
determine that the first content satisfies a threshold for the characteristic corresponding to a level of literacy; and
generate, responsive to the determination, the arrangement of elements that does not satisfy the threshold.

15. The system of claim 1, comprising the one or more processors configured to:
determine that the first content satisfies a threshold for the characteristic corresponding to a level of proficiency in a field; and
generate, responsive to the determination, the arrangement of elements that does not satisfy the threshold.

16. A method, comprising:
detecting, by one or more processors coupled with memory, one or more interactions with elements of content generated by one or more applications, the one or more interactions associated with an account;
identifying, by the one or more processors, based at least on the one or more interactions input into one or more models trained with machine learning on a plurality of interactions with a plurality of elements of content indicative of a plurality of characteristics, a characteristic associated with the account;
receiving, by the one or more processors, a first content for a payroll service to be displayed using a graphical user interface, the first content generated by an application of the one or more applications associated with the account;
generating, by the one or more processors, based at least on the first content, an arrangement of elements according to the characteristic; and
displaying, by the one or more processors, on the graphical user interface, the arrangement of elements.

17. The method of claim 16, comprising:
detecting, by the one or more processors, elements of the first content generated by the application responsive to a request associated with the account;
generating, by the one or more processors, a second content comprising the arrangement of elements of the first content based at least on a setting for the arrangement of elements associated with the characteristic; and
displaying, by the one or more processors on the graphical user interface, the second content responsive to the request.

18. The method of claim 16, comprising:
generating, by the one or more processors, responsive to the characteristic, a setting for the arrangement of elements to accommodate the characteristic;
storing, by the one or more processors, the setting into a profile of the account, the profile including one or more settings for one or more characteristics;
detecting, by the one or more processors, based at least on a portion of the first content input into the one or more models, that the portion of the first content corresponds to the characteristic; and
generating, by the one or more processors responsive to the detection, the arrangement of elements using the one or more models, the portion of the first content and the setting.

19. The method of claim 16, comprising:
determining, by the one or more processors, that the first content satisfies a threshold for the characteristic, the threshold corresponding to at least one of: a value of a decay function corresponding to anxiety, a word count, a language, visual impairment, a hearing impairment, a neurocognitive challenge, a level of literacy or a level of proficiency in a field; and
generating, by the one or more processors responsive to the determination, the arrangement of elements that does not satisfy the threshold for the characteristic.

20. A non-transitory computer-readable media having processor readable instructions, such that, when executed, cause at least one processor to:
detect one or more interactions with elements of content generated by one or more applications, the one or more interactions associated with an account;
identify, based at least on the one or more interactions input into one or more models trained with machine learning on a plurality of interactions with a plurality of elements of content indicative of a plurality of characteristics, a characteristic associated with the account;
receive a first content for a payroll service to be displayed using a graphical user interface, the first content generated by an application of the one or more applications associated with the account;
generate, based at least on the first content, an arrangement of elements according to the characteristic; and
display, on the graphical user interface, the arrangement of elements.
